(19) United States
(12) Patent Application Publication
(10) Pub. No.: US 2017/0022397 A1
(43) Pub. Date: Jan. 26, 2017

(54) FLOOR UNDERLAY

(71) Applicant: InstaFibre Ltd, Wokingham (GB)

(72) Inventor: Duonne Erasmus, Hilton (ZA)

(21) Appl. No.: 15/083,886

(22) Filed: Mar. 29, 2016

Related U.S. Application Data
(63) Continuation of application No. 14/514,091, filed on Oct. 14, 2014, now abandoned.
Application No. 14/514,091 is a continuation-in-part of application No. 13/811,146, filed on Mar. 22, 2013.

(30) Foreign Application Priority Data
Jul. 19, 2010 (GB) 1012088.9
Jul. 19, 2010 (GB) 1012089.7

(51) Int. Cl. C09J 7/02; E04F 15/18

(52) U.S. Cl. CPC C09J 7/0271; C09J 7/0246; C09J 7/0253; E04F 15/186; E04F 15/182; C09J 2201/122; C09J 2201/606; C09J 2421/006

(57) ABSTRACT

A product, generally in sheet form, and suitable for use as an underlay for a floor covering intended for permanent installation, including a layer comprising crumb-rubber material and having a first side and a second side. A coating of a high-grab pressure sensitive adhesive is applied directly to at least part of the exposed surface of the crumb-rubber material. The adhesive is determined to be a high-grab adhesive if, after 24 hours adhesive binding dwell-time, it has a 90° peel adhesion at 300 mm/minute, as measured by the FINAT Test Method No: 2, of between 4.35 and 21.76 Newtons/25 mm width at room temperature (23° C.±1° C.) and at a relative humidity of 50%±5%.

### CROSS REFERENCE TO RELATED APPLICATIONS

This Application is a Continuation of application Ser. No. 14/514,091 filed Oct. 14, 2014, which is a Continuation-in-Part of application Ser. No. 13/811,146, filed Jan. 18, 2013, which is a U.S. national stage application of International Patent Application Serial No. PCT/GB2011/001081, which claims the benefit of and priority from GB Application Nos. 1012089.7 and 1012088.9, both filed Jul. 19, 2010. The entire disclosures of these five applications are hereby incorporated by reference in their entireties.

### FIELD OF THE INVENTION

This disclosure relates to underlays, for example for floor coverings, and more particularly to crumb-rubber underlays.

### BACKGROUND

Crumb-rubber underlays in which the crumbs are bonded to each other and to form a continuous rubber matting with or without a supporting scrim layer on at least one side have been used as general purpose flooring underlays for over 40 years as they have a number of inherent properties that make them especially useful for the higher end of the market, namely:
relatively high mass per unit volume (density), which produces a material that has a high “flop-weight”;
highly efficient acoustic insulation properties as a consequence of its relatively high density;
the crumb-rubber particles, which make up 80-90% of the volume of the product, consist of vulcanised rubber and therefore cannot collapse over time;
an open-cell structure resulting from bonding of the rubber granules to one another during manufacture of the product using a synthetic rubber binder;
during compression of the product, the vulcanised rubber granules compress and then immediately rebound to their original shape once the pressure is released, so that the product always returns to its original shape and thickness after compression, regardless of the extent or duration of that compression;
as compared with a solid rubber sheet, the flexible open-cell structure allows the product to be compressed relatively easily when subjected to a point load, and yet provides a firm, non-collapsing surface when subject to a distributed load;
as compared with a solid rubber sheet, the more flexible open-cell structure allows the product readily to be rolled up into rolls which can then readily be packaged;
the open-cell structure allows air to flow freely through the material, making the product more “breathable” and more hygienic at the microbial level;
the open-cell structure allows better heat transfer through air circulation, but still has relatively good thermal insulation properties;
the product can be flooded and then dried in situ without altering performance or causing odours; and
exposed rubber granules form a surface that results in enhanced grip on most surfaces with which it comes into contact.

Despite these known properties and this long period of use, it appears that it was not until 2008 that any proposal was made for a crumb-rubber underlay to be provided with a coating of a pressure sensitive adhesive. Just such an underlay with a scrim material layer on at least one side to which a pressure sensitive adhesive is applied is proposed in ZA 2008/04310 of Rubber Lay (Pty) Ltd. No specific adhesive, nor any properties for such adhesive are suggested in ZA 2008/04310, save that the adhesive may be a pressure sensitive adhesive and may be directly applied or applied over a first coating of amorphous, high temperature, hot melt adhesive. The adhesive was disclosed in ZA 2008/04310 as being protected by a silicone release paper that could be removed by a floor-covering installer to expose the adhesive to allow the underside of the floor covering to be adhered to the exposed adhesive of the underlay.

It appears that this underlay may not have been a commercial success since Rubber Lay (Pty) Ltd went into voluntary liquidation in February 2009, only small sample volumes of their crumb-rubber underlay product having ever been produced.

### SUMMARY

The problem, glossed over in ZA 2008/04310, lies in the choice of adhesive. As will become clear from the detailed disclosure below, this problem had not been adequately solved by any specific product of Rubber Lay (Pty) Ltd. So far as the choice of adhesive is concerned, the present disclosure may be regarded as a selection from the broad disclosure of ZA 2008/04310. As explained below, this disclosure provides a solution to that problem.

Our analysis of potential applications for underlays, both traditional flooring underlays and other applications by extension, established that there was a need for two distinct types of underlay, namely those that call for high adhesive strength (hereafter: “high-grab”) for best results, and those that call for significantly lower adhesive strength (hereafter: “low-grab”) for best results.

Reference may be made to Table 1 below which, in addition to distinguishing between high-grab and low-grab for use with different flooring products, also identifies whether a 3 mm or 5 mm flat product or a 6 mm ribbed product gives best results.

TABLE 1

| | Low Grab Products | | | High Grab Products | | |
|---|---|---|---|---|---|---|
| Installation Types by Market | 3 mm | 5 mm | 6 mm | 3 mm | 5 mm | 6 mm |
| Segment | Flat | Flat | Ribbed | Flat | Flat | Ribbed |
| Commercial Segment | | | | | | |
| Carpet (wheeled Traffic) | | | | | | |
| Woven Broadloom (double stick) | | | | * | * | |
| Tufted Broadloom (double stick) | | | | * | * | |
| Tufted Tiles (double stick, no | | | | * | * | |
| replacement) | | | | | | |
| Needlepunch Broadloom (double stick) | | | | * | * | |
| Carpet (med/low traffic) | | | | | | |
| Woven Broadloom (single stick) | | | | * | * | * |
| Woven Broadloom (double stick) | | | | * | * | |
| Tufted Broadloom (single stick) | | | | * | * | * |
| Tufted Broadloom (double stick) | | | | * | * | |
| Tufted Tiles (double stick, | * | * | | | | |
| replacement) | | | | | | |
| Tufted Tiles (double stick, no | | | | * | * | |
| replacement) | | | | | | |
| Needlepunch Broadloom (single stick) | | | | | * | |
| Needlepunch Broadloom (double stick) | | | | * | * | |
| Needlepunch carpet tiles - | | | | | | |
| replacement required | | | | | | |
| Needlepunch tiles (backed, single | * | * | | | | |
| stick/double stick) | | | | | | |
| Needlepunch tiles - no replacement | | | | | | |
| Needlepunch tiles (backed/unbacked, | | | | * | * | |
| single/double stick) | | | | | | |
| Residential & DIY Segments | | | | | | |
| Carpet | | | | | | |
| Woven & Tufted Broadloom (single | | | | * | * | * |
| stick) | | | | | | |
| Tufted tiles | * | * | | * | * | |
| Needlepunch Broadloom (single stick) | | | | | * | |
| Needlepunch Broadloom (double stick) | | | | * | * | |
| Needlepunch Tiles (backed, | * | * | | | | |
| single/double stick, replacement) | | | | | | |
| Needlepunch Tiles (unbacked, | | | | * | * | |
| single/double stick) | | | | | | |
| Commercial, Residential & DIY | | | | | | |
| Segments | | | | | | |
| Wood (all single stick) | | | | | | |
| Tongue & Groove Solid floating | | | | * | * | |
| Tongue & Groove Engineered floating | | | | * | * | |
| Double-click Engineered floating | * | * | | | | |
| Laminate | * | * | | | | |
| Vinyl | | | | | | |
| Sheeting (double stick) | | | | * | | |
| Loose Rugs (non-slip, removable | * | | | | | |
| underlay) | | | | | | |

In accordance with a first aspect of the present disclosure, there is provided a product, generally in sheet form, and suitable for use as an underlay for a floor covering intended for permanent installation, the product including a layer comprising crumb-rubber material and having a first side and a second side, and a coating of a high-grab pressure sensitive adhesive applied to at least part of an exposed surface of the crumb-rubber material on at least one of the first and second sides, the adhesive being directly applied to a surface of the crumb-rubber material at said exposed surface. The high-grab adhesive comprises an adhesive having, after 24 hours adhesive binding dwell-time, a 90° peel adhesion at 300 mm/minute, as measured by FINAT Test Method No. 2, of between 4.35 and 21.76 Newtons/25 mm width at room temperature (23° C.±1° C.) and at a relative humidity of 50%±5%.

In accordance with a second and alternative aspect of the present disclosure, there is provided a product, generally in sheet form, and suitable for use as an underlay for a floor covering intended for permanent installation, the product comprising a layer comprising crumb-rubber material, and having a first and a second side. A coating of a high-grab pressure sensitive adhesive is applied directly to at least part of an exposed surface of at least one of the first and second sides without a scrim or other intervening layer being interposed between the adhesive and the crumb-rubber material layer. The high-grab adhesive comprises an adhesive having, after 24 hours adhesive binding dwell-time, a 90° peel adhesion at 300 mm/minute, as measured by the FINAT Test Method No. 2, of between 4.35 and 21.76 Newtons/25 mm width at room temperature (23° C.±1° C.) and at a relative humidity of 50%±5%.

In another aspect, embodiments of the invention include a method of manufacturing a product, generally in sheet form, and suitable for use as an underlay for a floor covering intended for permanent installation. The method includes manufacturing a scrim-less sheet comprising crumbs of rubber bonded to each other to each other to form a crumb-rubber layer. A pressure sensitive adhesive is applied directly to at least part of an exposed surface of the crumb-rubber layer. The adhesive, after 24 hours adhesive binding dwell-time, has a 90° peel adhesion at 300 mm/minute, as measured by FINAT Test Method No. 2, of between 4.35 and 21.76 Newtons/25 mm width at room temperature (23° C.±1° C.) and at a relative humidity of 50%±5%.

Preferred embodiments may have one or more of the following features. The crumb-rubber material suitably comprises individual crumbs of rubber bonded together by a bonding agent. A removable silicone-coated release sheet is adhered to the exposed adhesive surface.

### BRIEF DESCRIPTION OF THE DRAWINGS

Embodiments of underlay in accordance with the teachings of this disclosure are described in more detail hereinbelow by way of example only with reference to the accompanying drawings, in which:

FIG. 1 shows a somewhat schematic perspective side elevation of a portion of a first embodiment of underlay;

FIG. 2 shows a similarly schematic side elevation of a portion of a second embodiment of underlay;

FIG. 3 shows a similarly schematic side elevation of a portion of a third embodiment of underlay;

FIG. 4 shows a diagram illustrating a peel adhesion test employing the FINAT Test Method No: 2; and

FIG. 5 is a graph showing peel adhesion test results for test samples of adhesive applied at different coat weights, and for a comparative sample, in each case after 24 hours adhesive binding dwell-time.

### DESCRIPTION OF PREFERRED EMBODIMENTS

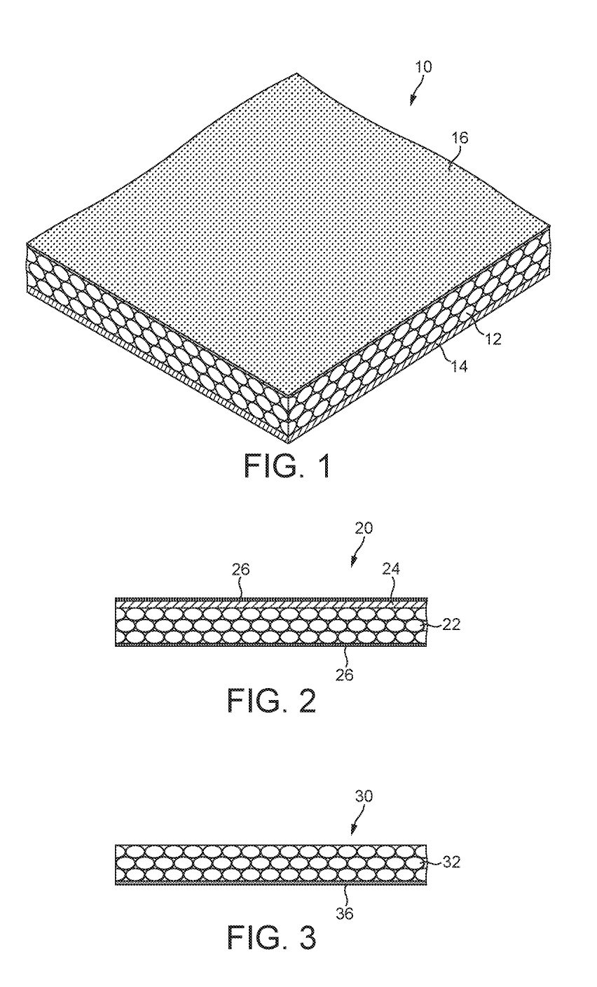

Referring first to FIG. 1, a generally sheet form underlay 10 includes a crumb-rubber layer 12 with scrim material 14 bonded to a first surface of the crumb-rubber layer. It will be understood that, in practice, the individual crumbs of the crumb-rubber layer will not be uniform in size or exclusively oval in section. Crumb rubber underlays with or without a bonded scrim layer are well known, as are their manufacturing techniques, and so only a brief description is deemed necessary here.

The scrim is bonded to the rubber crumbs and the crumbs to each other at the same time. The “wet” crumb-rubber compound (that is: including a synthetic rubber latex or natural rubber binder) is laid onto the scrim prior to moving under a doctor blade which skims the wet compound to the correct thickness. The scrim then carries the wet compound through the curing oven and, as the binder sets, it binds the crumb rubber particles to one another and, at the same time, to the scrim which is carrying the compound through the curing stenter oven. The thickness of the rubber layer is suitably between 2 mm and 15 mm. Preferred thicknesses for different forms of flooring are set out in Table 1 above, but other thicknesses within the above range may be used. For example, an 8 mm product would show enhanced acoustic performance. The rubber layer may be flat with a uniform thickness across both width and length of the underlay, as shown in FIG. 1, or may be undulating with a corrugated profile on its second side, as in the 6 mm ribbed version referred to in Table 1. The crumb-rubber layer may have a first side and a second side, with the two sides being generally opposite each other. In the particular embodiment illustrated in FIG. 1, a high-grab adhesive 16, as defined herein and explained in more detail below, is directly applied evenly to an exposed surface of the crumb-rubber layer without scrim material 14, i.e., to the side of the crumb-rubber layer without scrim material 14. The adhesive could equally well be applied in a pattern of spots or as uniform bands or overlapping swirl-spray strands across the surface of the crumb-rubber layer without scrim material.

The adhesive may additionally be applied to the scrim material, as shown in FIG. 2. FIG. 2 shows a similar underlay 20, which differs from that of FIG. 1 by having a crumb-rubber layer 22 with high-grab adhesive 26 applied to both the exposed crumb-rubber surface and the exposed scrim material layer 24.

The scrim material may be chosen from different weights of non-woven polypropylene, woven polypropylene, woven poly-jute, namely a combination of woven polypropylene and jute, jute, fiberglass reinforced cellulose, woven fiberglass, non-woven fiberglass, woven polyester, non-woven polyester, or of stitch bonded crepe paper, but is typically a 30 g/m² or 60 g/m² non-woven polypropylene. For practical manufacturing considerations, we prefer the 60 g/m² non-woven polypropylene.

In an alternative arrangement illustrated in FIG. 3, the product is scrim-less, with a high-grab adhesive 36 applied directly to one exposed surface of the crumb-rubber layer 32.

Prior to application of adhesive, the scrim-less product shown in FIG. 3 may be produced in conventional fashion by the steps of:
mixing the rubber crumbs with hot polyurethane until homogeneous;
pouring the mixture into a customized cylindrical mould and heating to about 90° C. under around 1 Bar pressure until cured;
removing the resultant cylinder from the mould and transferring it to a skiving machine in which a layer of the desired thickness, for example 8 mm, is peeled from the cylinder as it rotates past a skiving blade, the resulting crumb rubber sheet being re-wound on to a storage roll.

As the materials are compressed to form the cylinder, scrim-less crumb rubber underlays tend to have a higher density and smaller voids than equivalent thickness crumb rubber underlays formed on a scrim layer. This has advantages in certain circumstances, as the underlay has a higher tensile strength. The higher density means that the underlay is less easily compressed, which is useful for installation beneath vinyl or ceramic floorcoverings where too much compression of the underlay could cause problems of indentation of vinyl products and cracking of ceramic tiles.

Adhesive is applied to one or both surfaces of the scrim-less crumb-rubber sheet in exactly the same fashion as for the scrim-based products of FIGS. 1 and 2.

Although not illustrated, it will be understood that in all the above embodiments, a release sheet, suitably a film coated with a silicone release layer, covers the adhesive to protect it, and is peeled off before adhering the underlay to a floor or floor covering surface by the adhesive 16, 26 or 36.

The high-grab adhesive 16, 26 or 36 is important for installation of the flooring types for which it is intended, in order to get superior results. The present underlays with their high-grab adhesives are employed where placement in the correct position can be easily and quickly achieved and the flooring installation is intended to be permanent and not to require subsequent lifting.

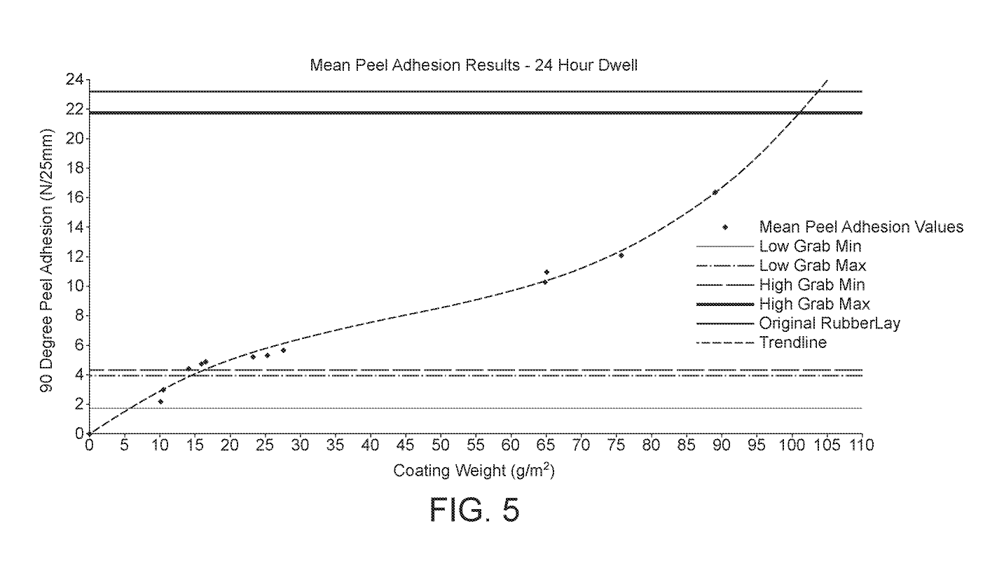

Tests for peel adhesion were performed with a number of samples using the FINAT Test Method No: 2 (as explained in more detail below). The results are set out in Table 2 (below) and FIG. 5.

Different adhesives show different characteristics, and we have established that neither choice of adhesive alone nor coat weight alone is an adequate indicator, but rather that peel adhesion is the only reliable measure of whether an adhesive present on a product in sheet form suitable for use as an underlay may be regarded as a high-grab adhesive or as a low-grab adhesive. As will be apparent from analysis of the test results explained below, the same adhesive may serve as a high-grab adhesive under some conditions and as a low-grab adhesive under others.

We achieved the test results shown in Table 2 and FIG. 5 using a commercially available adhesive, namely Unikem™ HPS 800 C, but other commercially available adhesives such as Henkel™ PD 1573 or Advanced Adhesives™ XM 2218 could equally well have been employed. The experimental data given in Table 2 and illustrated in graphical form in FIG. 5 is the mean of three replications at each coating weight of the adhesive. Peel adhesion was determined by the FINAT Test method No: 2 peel adhesion test performed after 24 hours adhesive binding dwell-time at room temperature (23° C.±1° C.) and at a relative humidity of 50%±5%, the temperature and humidity conditions of a typical laboratory. While the FINAT Test method No: 2 peel adhesion test performed after 20 minutes adhesive binding dwell-time, discussed in British Patent Application No: 1012088.9, can also produce results suggesting high-grab or low-grab characteristics, these results tend to be less reliable and less consistent than with the 24 hour adhesive binding dwell-time, and give spurious results with some coat weights, as a result of the much shorter adhesive binding dwell-time. Accordingly, we now much prefer the FINAT Test method No: 2 peel adhesion test after 24 hours adhesive binding dwell-time as a means of differentiating between high-grab, low-grab and neither. It is generally indicative of the final peel adhesion of practical underlays.

For the present tests, adhesive coating was achieved by using a Nordson™ BM200 Drum Melter in combination with a Nordson™ MX44160 Bulk Melter and a Nordson™ BC31-4/2100 Slot Nozzle Coating Head. In the Drum Melter a heated platen is forced down by two air cylinders on to a puddle of hot melt adhesive under the platen. The hot melt flows up into a positive displacement gear pump mounted on the platen and along a heated hose to the Bulk Melter, which has three main casting assemblies, namely hopper, grid and reservoir through which the hot melt passes. The reservoir has four positive displacement pumps at which the hot melt is forced through a filter and out into a heated hose to the Slot Nozzle Coating Head. A pressure transducer and pressure control valve is fitted in each pump outlet. The Slot Nozzle Coating Head has four shut-off valves to which the heated hoses are connected, and which control the flow of adhesive into the slot nozzle. They deliver the hot melt into the internal passages designed to ensure an even coating thickness across a width selected by a set of shims. The coating weight applied to a substrate, is determined in part by the rate at which the substrate passes the coating head and by the width over which the adhesive is applied. While the coat weight applied in a production run is much easier to determine, determination of the exact coat weight applied to a sample is more difficult. For different samples, coat weight may be varied by adjusting speed of movement of the sample through the machine. Thus, in order to produce a product, generally in sheet form, suitable for use as an underlay with high-grab characteristics, the manufacturing process should be varied by coat weight adjustment (which may be by speed of movement of the product through the coating machinery) until samples provide results by the FINAT Test method No: 2 peel adhesion test after 24 hours adhesive binding dwell-time within the limits prescribed above.

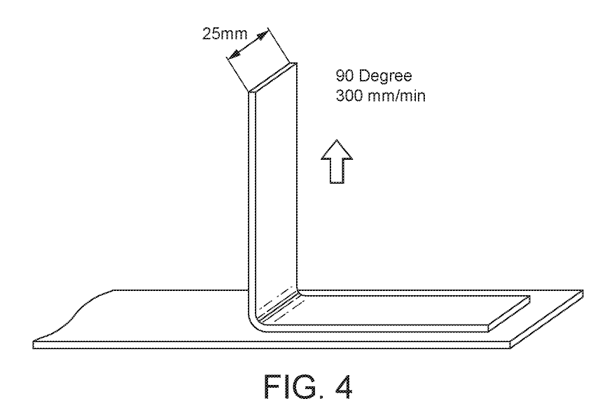

For details of peel adhesion testing by the FINAT Test Method No: 2, reference may be made to “FINAT Technical Handbook—Test Methods”, 8^{th} Edition, published by FINAT. This test provides an industry standard test for peel adhesion, which involves the use of test strips of rubber that are 25 mm wide and 200 mm long and are adhered to a glass substrate for an adhesive binding dwell-time of either 20 minutes or 24 hours and then pulled apart on a test rig at an angle of 90° by drawing an edge of the rubber strip perpendicularly away from the glass substrate at 300 mm/minute, and measuring the force required to achieve this, as indicated schematically in FIG. 4. A wide range of test equipment is commercially available from different manufacturers to carry out these tests. The tests for the samples of Table 2 (below) and FIG. 5 were performed using a Cheminstruments™ AR-1500 Adhesion Release Tester. Another suitable tester is a JJ Lloyd LR 30K plus Tensometer. The tests were performed at room temperature (23° C.±1° C.) and at a relative humidity of 50%±5%, temperature and humidity conditions found in a typical test laboratory. The results after 24 hours of adhesive binding dwell-time are regarded as the ultimate values, which are unlikely to improve even after extended periods. For comparison, the same tests were performed using a sample of the original RubberLay™ material.

TABLE 2

| | Newtons/25 mm after | |
|---|---|---|
| | 24 Hours Adhesive | |
| | Binding Dwell Time at | |
| | Room Temperature | Coating Weight |
| Sample ID | (23° C. +/− 1° C.) | (g/m²) |
| Low Grab | 1.77 | |
| Minimum | | |
| 1 | 2.20 | 10.00 |
| 2 | 3.01 | 10.40 |
| Low Grab | 3.96 | |
| Maximum | | |
| High Grab | 4.35 | |
| Minimum | | |
| 3 | 4.40 | 13.97 |
| 4 | 4.46 | 14.00 |
| 5 | 4.75 | 15.84 |
| 6 | 4.89 | 16.44 |
| 7 | 5.23 | 23.20 |
| 8 | 5.33 | 25.20 |
| 9 | 5.68 | 27.52 |
| 10 | 10.27 | 64.92 |
| 11 | 10.96 | 65.20 |
| 12 | 12.09 | 75.84 |
| 13 | 16.37 | 89.20 |
| High Grab | 21.76 | |
| Maximum | | |
| Original RubberLay | 23.20 | |

FIG. 5 shows the same results graphically, with a “best fit” line drawn through the data points, to which a zero coat weight point has been added, given that zero coat weight will necessarily show zero peel adhesion. There are relatively few data points at low coat weights, as it is inherently technically difficult to apply low coating weights. Even so, it will be seen that the “best-fit” line is a relatively poor fit for the first few data points. In reality, at very low coat weights, there is virtually no adhesion. Then, at a threshold coat weight, which for this particular adhesive appears to be at around 10 g/m², the peel adhesion increases very rapidly with added coat weight, before leveling out with a peel adhesion of a little under 6 Newtons/25 mm at a coat weight of between 20 and 30 g/m² for this particular adhesive. At much higher coat weights, the rate of increase of peel adhesion with added coat weight again increases.

It transpires that it is in the region of rapid increase of peel adhesion with coat weight at lower coat weights, that the adhesive exhibits low-grab properties, while peel adhesions in the range of coat weights for which the peel adhesion levels off exhibit high-grab properties. This was established by carrying out test installations with samples of the coated underlay and different floor coverings.

We found that Sample IDs 1 and 2 allowed practical release from the floor covering. Carpet tiles could be removed from the underlay with their backing intact. Wood laminate could also be readily uplifted after installation, thereby enabling ready replacement of the floor covering. Similar release characteristics were found below rugs. The underlay could be removed from the rug and subsequently replaced. Thus Sample IDs 1 and 2 were characterized as low-grab.

However, when these same practical installation tests were repeated for Sample ID 3, when removing carpet tiles, some of the backing from the carpet tiles came away and remained on the underlay. When attempting to uplift a wood laminate, we found that it did not easily pull away. In some cases, the underlay was damaged when the laminate was removed. Accordingly, Sample ID 3 was not suitable for use where potential replacement of the floor covering may occur. It could not be characterized as a low-grab adhesive, and should be characterized as a high-grab adhesive at the lower end of the high-grab range.

Sample IDs 4 to 13 also exhibited high-grab characteristics.

The single sample of the original RubberLay™ material exhibited a very high peel adhesion significantly beyond that of any of our own test samples. It proved so fierce in practical installation tests that it provided no margin for any error during application, and so did not represent a practicable option even for installations requiring high-grab characteristics.

We have used the above test data to establish practical boundaries between low-grab and high-grab adhesives in terms of peel adhesion. Given that Sample ID 3 with a peel adhesion of 4.40 Newtons/25 mm had been established as exhibiting high-grab characteristics, while Sample ID 2 with a peel adhesion of 3.01 Newtons/25 mm worked well in installations that required a low-grab adhesive, we set the minimum boundary for high-grab adhesives at 1% below the Sample ID 3 level, namely at 4.35 Newtons/25 mm, and the maximum peel adhesion for low-grab characteristics at 10% below the Sample ID 3 level, namely at 3.96 Newtons/25 mm.

A minimum peel adhesion of 1.77 Newtons/25 mm for a low-grab adhesive is effectively set by the practical problems in applying adhesive at very low coat weights. We were able to produce a single sample having a coat weight of 3g/m² that exhibited a peel adhesion of 1.01 Newtons/25 mm. When this single sample was tested in practical installations calling for low-grab characteristics, it did not perform well, as it provided insufficient adhesion. The floor covering tended to move after application to the underlay. A practical lower limit for peel adhesion for satisfactory results can be set by taking the midpoint between this single unsatisfactory sample and Sample ID 1, which was known to have satisfactory low-grab characteristics, and adding 10%.

A practical maximum for peel adhesion for practicable high-grab characteristics can be established from the fact that Sample ID 13 with a peel adhesion of 16.37 Newtons/25 mm performed well as a high-grab product, whereas the original RubberLay™ material exhibited a peel adhesion of 23.20 Newtons/25 mm but was too fierce to be practicable. Accordingly, we can set a practical upper limit for high-grab peel adhesion by taking the midpoint between these figures and adding 10%, resulting in a practical upper limit of 21.76 Newtons/25 mm.

The above figures for peel adhesion will determine practicable low-grab and high-grab products, regardless of the particular adhesive. Repeating the peel adhesion tests with a different adhesive, for example Henkel™ PD 1573 or Advanced Adhesives™ XM 2218, using samples having varying coat weights, would give a similar set of data points with a similar best-fit curve, but with the coat weights for the peel adhesion values required for low-grab and for high-grab being at different figures from those shown in Table 2 for Unikem™ HPS 800 C.

Thus, in order to produce a product, generally in sheet form, suitable for use as an underlay with high-grab characteristics, with a selected adhesive, whether one of those mentioned above or any other commercially available pressure sensitive adhesive, the manufacturing process should be varied by coat weight adjustment (which may be by speed of movement of the product through the coating machinery) until samples provide results by the FINAT Test method No: 2 peel adhesion test after 24 hours adhesive binding dwell-time that are within the limits for high-grab prescribed above.

Although the above description with reference to FIGS. 1 to 3 is in terms of use only of high-grab adhesives, we also contemplate a product in which high-grab adhesive is applied to one surface of the crumb rubber layer and a low-grab adhesive, with peel adhesion within the limits for low-grab prescribed above, is applied to the other surface of the crumb rubber layer. In use of this embodiment, we contemplate that the low-grab adhesive side would usually be applied to the sub-floor, while the high-grab adhesive side would be adhered to the floor covering in a context where permanent adhesion of the floor covering is desired. Alternatively, this could be reversed, with the high-grab adhesive adhered to the sub-floor and the low-grab adhesive adhered to the floor covering, which would prove useful in circumstances where the floor covering may need to be replaced from time to time, as when individual carpet tiles become soiled and need to be moved to another location or replaced with new ones.

In an alternative arrangement, there may be a high-grab adhesive applied directly to one side of a scrim-less crumb-rubber layer, with a high-grab adhesive also applied directly to the other side of the crumb-rubber layer.

What is claimed is:

1. A product, generally in sheet form, and suitable for use as an underlay for a floor covering intended for permanent installation, the product comprising:
a layer comprising crumb-rubber material and having a first side and a second side without a scrim or other strengthening layer applied to the crumb-rubber layer on the first side thereof, and without a scrim or other strengthening layer applied to the crumb-rubber layer on the second side thereof; and
a coating of a high-grab pressure sensitive adhesive applied directly to at least part of an exposed surface of the crumb-rubber material on at least one of the first and second sides.
wherein the high-grab adhesive comprises an adhesive having, after 24 hours adhesive binding dwell-time, a 90° peel adhesion at 300 mm/minute, as measured by FINAT Test Method No. 2, of between 4.35 and 21.76 Newtons/25 mm width at room temperature (23° C.±1° C.) and at a relative humidity of 50%±5%.

2. A product according to claim 1, wherein the crumb-rubber material comprises individual crumbs of rubber bonded together by a bonding agent.

3. A product according to claim 1, wherein the high-grab adhesive is applied directly to at least part of the surface of the crumb-rubber material at the exposed surfaces on both the first and second sides.

4. A product according to claim 1, further comprising a release sheet adhered to an exposed adhesive coated surface.

5. A product, generally in sheet form, and suitable for use as an underlay for a floor covering intended for permanent installation, the product consisting essentially of:
a first layer comprising crumb-rubber material and having a first side and a second side;
a second layer consisting of a coating of a high-grab pressure sensitive adhesive applied directly to at least part of an exposed surface of the crumb-rubber material on at least one of the first and second sides; and
a third layer comprising a release sheet adhered to an exposed adhesive coated surface;
wherein the high-grab adhesive comprises an adhesive having, after 24 hours adhesive binding dwell-time, a 90° peel adhesion at 300 mm/minute, as measured by FINAT Test Method No. 2, of between 4.35 and 21.76 Newtons/25 mm width at room temperature (23° C.±1° C.) and at a relative humidity of 50%±5%.

6. A product, generally in sheet form, and suitable for use as an underlay for a floor covering intended for permanent installation, the product consisting essentially of:
a first layer comprising crumb-rubber material and having a first side and a second side
a second layer consisting of a coating of a high-grab pressure sensitive adhesive applied directly to at least part of an exposed surface of the crumb-rubber material on the first side;
a third layer comprising a release sheet adhered to an exposed surface of the second layer;
a fourth layer consisting of a coating of a pressure sensitive adhesive, selected from a group consisting of the high-grab pressure sensitive adhesive and a low-grab pressure sensitive adhesive, applied directly to at least part of an exposed surface of the crumb-rubber material on the second side; and
a fifth layer comprising a release sheet adhered to an exposed surface of the fourth layer;
wherein the high-grab adhesive comprises an adhesive having, after 24 hours adhesive binding dwell-time, a 90° peel adhesion at 300 mm/minute, as measured by FINAT Test Method No. 2, of between 4.35 and 21.76 Newtons/25 mm width at room temperature (23° C.±1° C.) and at a relative humidity of 50%±5%; and
wherein the low-grab adhesive comprises an adhesive having, after 24 hours adhesive binding dwell-time, a 90° peel adhesion at 300 mm/minute, as measured by FINAT Test Method No. 2, of between 1.77 and 3.96 Newtons/25 mm width at room temperature (23° C.±1° C.) and at a relative humidity of 50%±5%.
